(19) United States
(12) Patent Application Publication
(10) Pub. No.: US 2011/0281201 A1
(43) Pub. Date: Nov. 17, 2011

(54) SYSTEM AND METHOD FOR FORMING CONDUCTORS OF AN ENERGY GENERATING DEVICE

(75) Inventors: Milton B. Hollander, Stamford, CT (US); James J. Ferguson, Mullica Hill, NJ (US)

(73) Assignee: OMEGA Engineering, Inc., Stamford, CT (US)

(21) Appl. No.: 13/093,977

(22) Filed: Apr. 26, 2011

Related U.S. Application Data
(60) Provisional application No. 61/343,294, filed on Apr. 26, 2010.
(60) Provisional application No. 61/328,443, filed on Apr. 27, 2010.
(60) Provisional application No. 61/329,788, filed on Apr. 30, 2010.
(60) Provisional application No. 61/352,608, filed on Jun. 8, 2010.

(51) Int. Cl. H01M 4/64; H01R 43/00; H01M 8/10

(52) U.S. Cl. 429/495; 429/517; 29/874

(57) ABSTRACT

An electrical circuit is presented that includes an anode conductor formed from a first wire and a cathode conductor formed from a second wire. The first wire and the second wire each comprised of a predetermined diameter. At least a portion of the predetermined diameter of the wires is compressed or extruded to provide an increased surface area. The conductors are disposed about an electrolyte material of an energy generating device, e.g., a fuel cell. The increased surface area of the leads increases a total collected energy of the fuel cell without increasing the conductor mass or tensile strength such that weight and other characteristics of the fuel cell are not adversely impacted as compared to conventional fuel cell arrangements.

### CROSS-REFERENCE TO RELATED APPLICATIONS

This patent application claims priority benefit under 35 U.S.C. §119(e) of co-pending U.S. Provisional Patent Application Nos. 61/343,294; 61/328,443; 61/329,788; and 61/352,608, filed on Apr. 26, 2010, Apr. 27, 2010, Apr. 30, 2010, and Jun. 8, 2010 respectively. Each of the foregoing U.S. Provisional Patent Applications is a continuation of co-pending U.S. patent application Ser. No. 12/567,018, filed Sep. 25, 2009, which claims priority to U.S. Provisional Patent Application, Ser. No. 61/218,723, filed Jun. 19, 2009. The disclosures of these U.S. patent applications are incorporated by reference herein in their entireties.

### BACKGROUND

1. Field of the Invention

The present invention relates generally to fuel cells for powering a process and/or an apparatus and, more particularly, to a system and method for increasing electrical energy collection of fuel cell conductors.

2. Description of Related Art

Energy generating devices such as, for example, fuel cells and catalytic converters, are well known. Generally speaking, a fuel cell generates electricity by combining hydrogen with oxygen. For example, in a solid oxide fuel cell (SOFC) electricity is produced directly from oxidizing a fuel. SOFC devices include a solid oxide, or ceramic, electrolyte. Advantages of this class of fuel cells include high efficiencies, long term stability, fuel flexibility, low emissions, and cost. A perceived disadvantage is that high operating temperature results in longer start up times and mechanical/chemical compatibility issues.

In operation, oxygen is reduced into oxygen ions at a cathode. The oxygen ions then diffuse through the solid oxide electrolyte to an anode where they electrochemically oxidize fuel (e.g., light hydrocarbons such as methane, propane, butane, and the like) in the fuel cell. In the oxidizing reaction water is a typical byproduct as well as two electrons. The electrons then flow through an external circuit as usable electricity. The inventors have recognized that a need exists to improve the collection of electrical energy within fuel cells.

### SUMMARY

The present invention resides in one aspect in an electrical circuit, that includes an anode conductor including a first wire; a cathode conductor including a second wire; and the first wire and the second wire each having a predetermined diameter, at least a portion of the predetermined diameter of at least one of the first wire and the second wire is formed into a shaped portion having a plurality of surfaces, the plurality of surfaces providing an increased surface area of the shaped portion as compared to a remainder of the predetermined diameter.

Another aspect of the invention resides in a method of increasing a surface area of at least one of an anode conductor and a cathode conductor, the method includes providing at least one of an anode conductor and a cathode conductor, the anode conductor comprising a first wire and the cathode conductor comprising a second wire, each of the first wire and the second wire having a predetermined diameter; and forming at least a portion of the predetermined diameter of at least one of the first wire and the second wire into a shaped portion having a plurality of surfaces, the plurality of surfaces providing an increased surface area of the shaped portion as compared to a remainder of the predetermined diameter.

### BRIEF DESCRIPTION OF THE DRAWINGS

The foregoing aspects and other features of the presently disclosed embodiments are explained in the following description, taken in connection with the accompanying drawings, wherein:

FIG. 1 is a simplified schematic diagram of a fuel cell having at least one conductor providing improved electrical energy collection capability;

FIGS. 2A and 2B depict a lead wire having a flattened or compressed portion;

FIG. 2C depicts the lead wire of FIGS. 2A and 2B having a folded accordion-shaped portion;

FIGS. 3A-3D depict the flattened or compressed lead wire being folded or bent back into the accordion-shaped portion or a serpentine portion; and

FIGS. 4A and 4B depict a lead wire formed into a shape having a plurality of surfaces.

### DETAILED DESCRIPTION

As described herein, the inventors have discovered that electrical energy collection is improved by increasing a surface area of conductors of an external circuit coupled to an energy generating device such as, for example, a fuel cell, a catalytic converter, and like devices. An increase in the surface area of one or more of the conductors increases a total collected energy produced by the energy generating device. The inventors have further discovered that it would be advantageous to provide conductors having increased surface area without increasing a mass of the conductors and without reducing the tensile strength of the conductor or its cross sectional area, so as not to compromise weight and other characteristics of the energy generating device.

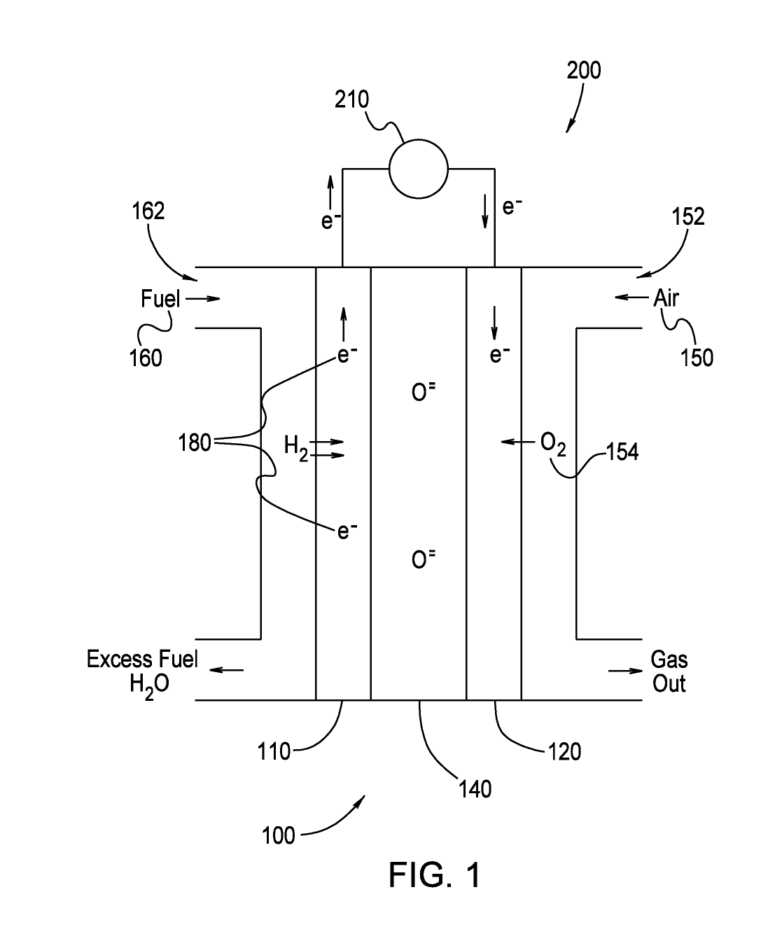

FIG. 1 is a simplified schematic diagram of an energy generating device 100 such as, for example, a solid oxide fuel cell, for producing electricity to power an external electrical circuit 200. The fuel cell 100 includes an anode conductor 110 and a cathode conductor 120 disposed about an electrolyte material 140 such as, for example, a solid oxide or ceramic electrolyte. As is generally known in the art, oxygen 150 (e.g., air) is fed into the fuel cell 100 via an inlet 152 and a fuel 160 such as, for example, a light hydrocarbon, is introduced to the fuel cell 100 via an inlet 162.

As shown in FIG. 1, the oxygen 150 is reduced into oxygen ions (O₂) 154 at the cathode conductor 120. The O₂ 154 diffuses through the electrolyte material 140 to the anode conductor 110 to electrochemically oxidize the fuel 160. In the oxidizing reaction, electrons (e−) 180 are produced. The e− 180 flow from the anode conductor 110 to the cathode conductor 120 through the external electrical circuit 200 as electricity that may be used, for example, to power a process or an apparatus 210 of the external circuit 200.

It should be appreciated that, while the energy generating device 100 is described hereinafter as a fuel cell, it is within the scope of the present disclosure for the energy generating device 100 to be a catalytic converter where a liquid such as, for example, water, undergoes a catalytic reaction for its dissociation into a hydrogen ion and an electron (e.g., e− 180).

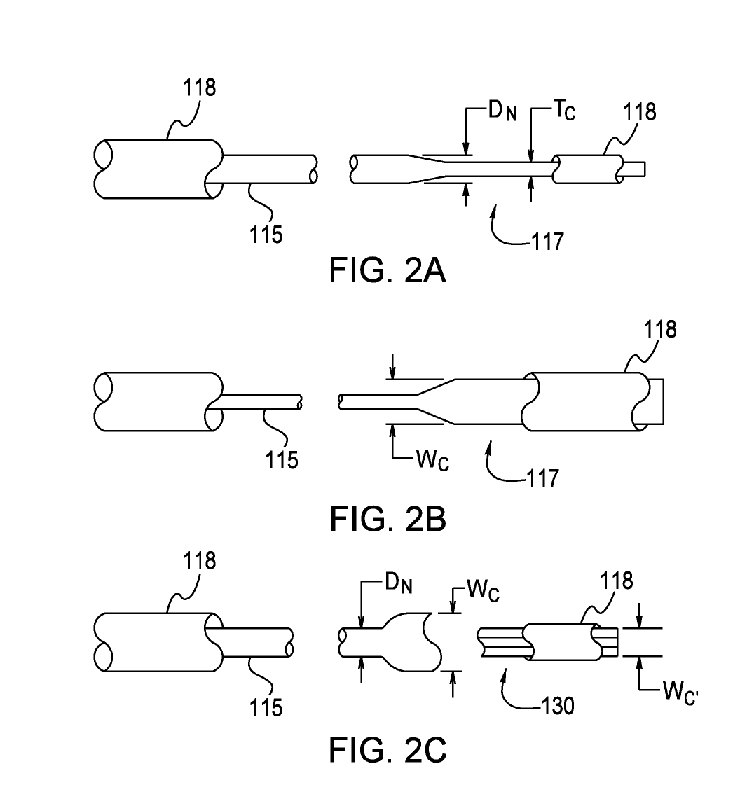

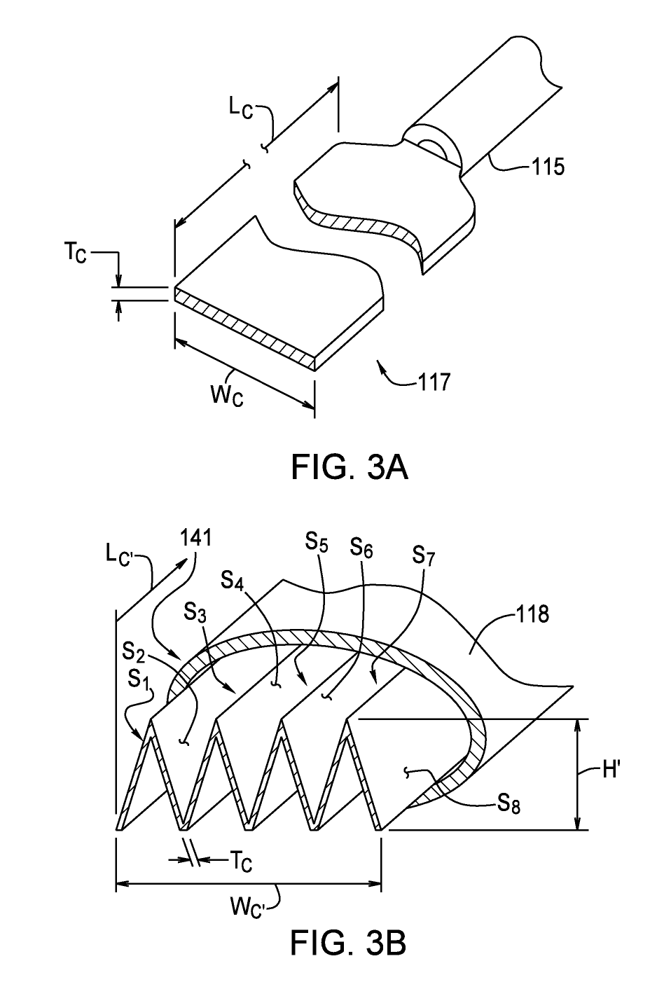

In accordance with the present invention, at least one of the anode conductor 110 and the cathode conductor 120 is comprised of a wire 115 (FIGS. 2A-2C, 3A and 4A) such as, for example, a nickel or nickel-based wire. In one embodiment, the nickel-based wire is comprised of a nickel-silicon alloy such as, for example, an alloy sold under the brand name NISIL™ by Omega Engineering, Inc. (Stamford, Conn. USA). In one embodiment, the nickel or nickel-based wire conductor 115 is comprised of a wire having a nominal diameter D_{N} in a range of about 0.010 inch (0.2546 mm) to about 0.250 inch (6.350 mm). It should be noted that a wire of diameter D_{N} of about 0.010 inch (0.2546 mm) to about 0.250 inch (6.350 mm) has a surface area of between about 0.0314 sq. in. per inch (20.26 mm² per mm) of length to about 0.785 sq. in. per inch (506.45 mm² per mm) of length.

In one embodiment, the nickel or nickel-based wire anode conductor 110 collects energy generated by the energy generating device 100 (e.g., the fuel cell), for example, the e− 180. The nickel or nickel-based wire anode conductor 110 is a lead to the external electrical circuit 200 coupling the process or apparatus 210 to the fuel cell 100. In one embodiment, the nickel or nickel-based wire cathode conductor 120 is a lead from the external electrical circuit 200 back to the fuel cell 100.

In one aspect of the invention, a portion 117 of the diameter D_{N} of the wire conductors 115, e.g., the anode conductor 110 and/or the cathode conductor 120, is compressed or flattened from a round cross section to increase the surface area by at least about two (2) times. This is accomplished, for example, by flattening or compressing the portion 117 of the wire 115 of about 0.020 inch (0.508 mm) in diameter to about 0.005 inch (0.127 mm). When flattened, the portion 117 of the wire has a width W_{C} of about 0.045 inch (1.143 mm), is ribbon like, and has about the same cross section area (0.0314 square inches, 0.7976 mm) as the original round wire (e.g., the diameter D_{N}), but now the portion 117 has a thickness T_{C} of about 0.005 inch (0.127 mm). In this exemplary embodiment, the wire of diameter D_{N} of about 0.020 inch (0.508 mm) has a surface area of about 0.0634 sq. in. per inch (40.90 mm² per mm) of length, and the compressed wire conductor 117 has a surface area of about 0.1045 sq. in. per inch (67.42 mm² per mm) of length. Accordingly, the compression improves the surface area by about two (2) times.

It should be appreciated that by compressing or flattening the existing nickel or nickel-based wire conductors 115 of the fuel cell 100 neither the conductor mass or tensile strength is increased so that, for example, the fuel cell 100 increases total collected energy without increasing weight and other characteristics as compared to conventional fuel cell arrangements. It should also be appreciated that the increased surface area improves conductivity of the conductors 115 as well as connectivity (e.g., line contact versus point contact).

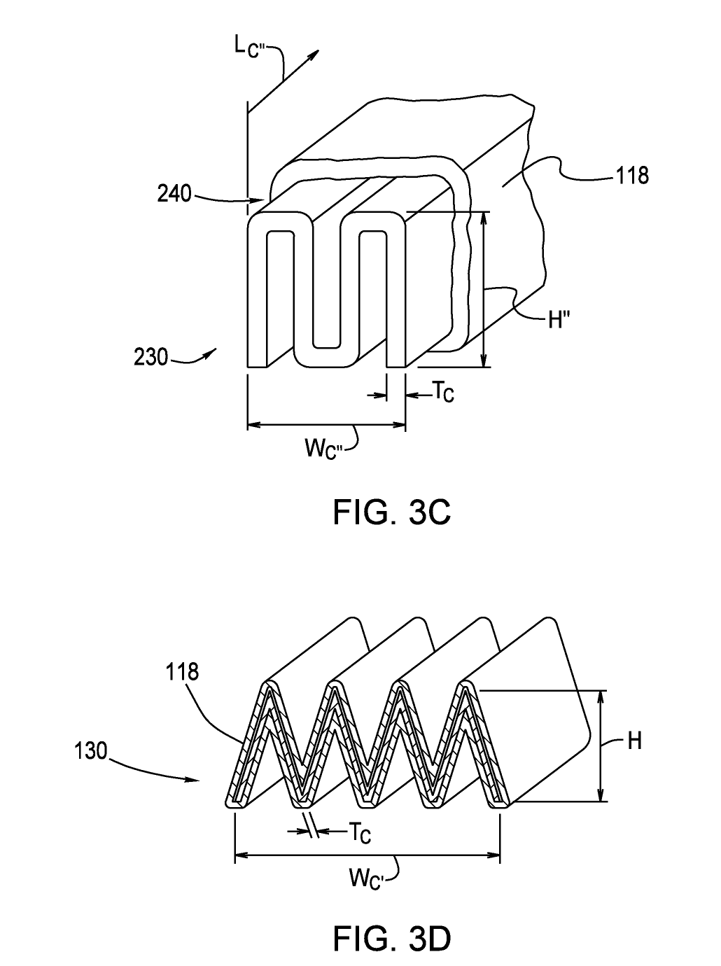

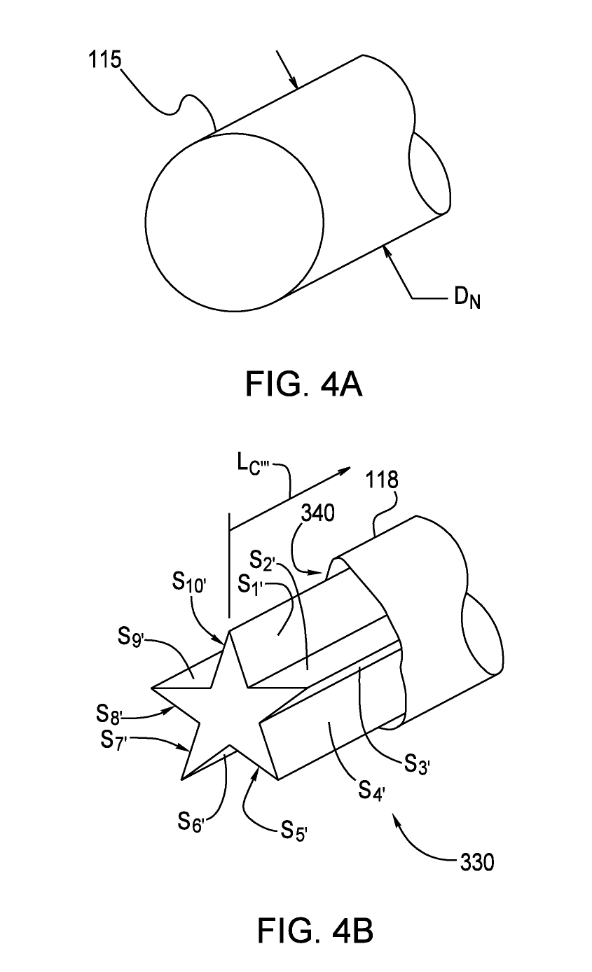

In one embodiment, the compressed wire conductor is replaced by a wire ribbon having the same cross sectional area as the compressed wire (e.g., the portion 117 represents an entire length of the wire 115). In one embodiment, as illustrated herein, one or both of the anode wire conductor 110 and/or the cathode wire conductor 120 is coated with or covered by a high temperature, porous, non-conducting insulation or braiding 118 such as, for example, a ceramic, ceramic-like or silicon insulator or a braided sleeve. In one embodiment, the ceramic-like insulation is an alumina-boria-silica insulation. In one embodiment, the braiding is a high temperature braided sleeving such as, for example, a NEXTEL® braided sleeving (Nextel is the registered trademark of 3M Company, St. Paul, Minn., USA). As shown in FIG. 3D, in one embodiment, the non-conducting insulation or braiding 118 is coated on each of the plurality of surfaces of a shaped portion 130. While FIG. 3D illustrates a generally accordion-shaped portion 130, it is contemplated that the shaped portion 130 may be of any shape, including, but not limited to a generally serpentine-shaped portion (similar to FIG. 3C), or a shaped portion formed by extrusion through a die (as shown in FIG. 4B).

In various embodiments, illustrated in FIGS. 3A-3C, the compressed portion 117 of the wire conductor 115 is folded or bent back into, for example, a generally accordion-shaped portion 130 (FIG. 3B) or a generally serpentine portion 230 (FIG. 3C) over at least a portion of its length L_{C}′ and L_{C}″. The inventors have recognized that pressing, folding, forming, collapsing and/or bending the width W_{C} into, for example, the accordion-shaped portion 130, the serpentine shape 230 or like shape to form a rectangular exterior perimeter permits a reduction in the width of the compressed portion 117 from the width W_{C} to widths W_{C}′ and W_{C}″. However, the reduction in width does not diminish the desirable aspects of the present invention such as, for example, maintaining substantially the same mass and tensile strength while also providing an increased surface area of the compressed portion.

As shown in FIGS. 3B and 3C, the collapsing of the width W_{C} into the widths W_{C}′ and W_{C}″ results in a formation of a height H′ of the accordion-shaped portion 130 and a height H″ of the serpentine-shaped portion. In one embodiment, the widths W_{C}′ and W_{C}″ and corresponding heights H′ and H″ of the accordion-shaped portion 130 and serpentine-shaped portion 230 of the compressed wire conductor define generally rectangular exterior perimeters 141 and 240 suitable for coating, as described below. In one embodiment, the widths W_{C}′ and W_{C}″ and corresponding heights H′ and H″ of the compressed wire conductor approximates the diameter D_{N} the original round wire 115 such that the compressed wire conductor maintains a similar cross-sectional dimension as the original wire but with a substantially increased surface area.

For example, as noted above, the portion 117 of the round cross-sectional wire 115 is compressed or flattened from a diameter of about 0.020 inch (0.508 mm) to the thickness of about 0.005 inch (0.127 mm) and the width W_{C} of about 0.045 inch (1.143 mm). In one embodiment, the width W_{C} is folded seven (7) times to form eight (8) folded surfaces S₁-S₈ (FIG. 3B) such that the width W_{C}′ is about one eighth (⅛) of the width W_{C} or about 0.00562 inch (0.1427 mm). In this embodiment, as the width is divided equally, the height H′ is also about 0.00562 inch (0.1427 mm). In one embodiment, the accordion-shaped portion 130 represents substantially an entire length of the compressed wire conductor such that, in this exemplary embodiment, the compressed accordion-shaped wire conductor has the width W_{C}′ and height H′ each of about 0.00562 inch (0.1427 mm) along substantially its entire length L_{C}′.

It should be appreciated that it is within the scope of the present invention to vary the number of bends or folds in any manner to achieve desired widths W_{C}′ and W_{C}″ and heights H′ and H″. Moreover, the width and height need not be substantially the same, as is described above, as it is within the scope of the present invention to vary the number of folds or bends to achieve varying dimensions. It should be appreciated that the number of folds or bends does not significantly diminish the surface area improvements achieved, as described herein, by compressing or flattening the wire conductors.

In one aspect of the invention, as illustrated in FIGS. 4A and 4B, the portion 117 of the diameter D_{N} of the wire conductors 115, e.g., the anode conductor 110 and/or the cathode conductor 120, is pulled, pushed, pressed, extruded, stamped or otherwise passed through a die to form a shape 330 having a plurality of surfaces, e.g., a star shape having surfaces S₁′-S₁₀′ is shown, resulting in an increase in a surface area of the shaped portion 330 while keeping a substantially similar cross-sectional area as the diameter D_{N} of the wire 115. In one embodiment, the surface area of the shaped portion 330 is increased by at least about two (2) times.

It should be appreciated that by forming and/or shaping the existing nickel or nickel-based wire conductors 115 of the fuel cell 100 neither the conductor mass or tensile strength is increased so that, for example, the fuel cell 100 increases total collected energy without increasing weight and other characteristics as compared to conventional fuel cell arrangements. It should also be appreciated that the increased surface area improves conductivity of the conductors 115 as well as connectivity (e.g., line contact versus point contact). While FIG. 4B depicts the shaped portion 330 as a star shape, it is within the scope of the present invention to form other shapes through pulling, pushing, pressing, extruding, stamping or otherwise passing through a die to form a shape 330 defining a plurality of surfaces to achieve the increased surface area. For instance, the shaped portion 330 may be accordion-shaped (similar to FIG. 3B) or serpentine-shaped (similar to FIG. 3C).

In various embodiments, illustrated in FIGS. 2C, 3B, 3C and 4B, the exterior perimeter 141 of the accordion-shaped portion 130, the exterior perimeter 240 of the serpentine-shaped portion 230 and an exterior perimeter 340 of the shaped portion 330 are coated with or covered by the aforementioned high temperature, porous, non-conducting insulation or braiding 118 such as, for example, a ceramic, ceramic-like or silicon insulator, or braided sleeve. It should be appreciated that at least one advantage of the widths W_{C}′ and W_{C}″ and heights H′ and H″ of the accordion-shaped 130 and the serpentine-shaped 230 wire conductors defining generally rectangular exterior perimeters 141 and 240 is that the coating, wrapping and/or braiding operation on the rectangular shaped conductor is made more efficient, practical and/or easier. For example, one skilled in the art recognizes that certain disadvantages in coating, wrapping or braiding a substantially flat component are minimized, if not eliminated, when coating a round or rectangular component.

In one embodiment, the coated accordion-shaped portion 130, the coated serpentine portion 230, and the coated shaped portion 330 are each a substantially entire length L_{C}′, L_{C}″ and L_{C}′″ of the wire conductors such as one or both of the anode wire conductor 110 and/or the cathode wire conductor 120. For example, FIG. 2C illustrates aspects of the present invention on one lead wire. It should be appreciated that a lead wire formed, in accordance with the present invention, need not comprise each of the depicted diameter portion D_{N}, flattened or compressed portion 117, accordion-shaped portion 130, serpentine portion 230 and the shaped portion 330.

The foregoing description is only illustrative of the present embodiments. Various alternatives and modifications can be devised by those skilled in the art without departing from the embodiments disclosed herein. Accordingly, the embodiments are intended to embrace all such alternatives, modifications and variances which fall within the scope of the present disclosure and one or more of the appended claims.

What is claimed is:

1. An electrical circuit, comprising:
an anode conductor including a first wire;
a cathode conductor including a second wire; and
the first wire and the second wire each having a predetermined diameter, at least a portion of the predetermined diameter of at least one of the first wire and the second wire is formed into a shaped portion having a plurality of surfaces, the plurality of surfaces providing an increased surface area of the shaped portion as compared to a remainder of the predetermined diameter.

2. The electrical circuit of claim 1, wherein the shaped portion maintains a same cross-sectional area as the remainder of the predetermined diameter as well as the increased surface area.

3. The electrical circuit of claim 1, wherein the shaped portion is a compressed portion folded to form a width and a height that define a generally rectangular exterior perimeter.

4. The electrical circuit of claim 3, wherein the compressed folded portion is comprised of an accordion-shaped portion.

5. The electrical circuit of claim 3, wherein the compressed folded portion is comprised of a serpentine-shaped portion.

6. The electrical circuit of claim 1, wherein the shaped portion is a star shape.

7. The electrical circuit of claim 1, wherein the increased surface area of the shaped portion is at least about two times a surface area of the predetermined diameter.

8. The electrical circuit of claim 1, wherein the first and the second wires are nickel or nickel-based.

9. The electrical circuit of claim 1, wherein a portion of one or both of the first wire and/or the second wire is covered by a high temperature, porous, non-conducting insulation or braiding.

10. The electrical circuit of claim 9, wherein the insulation is comprised of at least one of a ceramic insulator, a ceramic-like insulator, and a silicon insulator.

11. The electrical circuit of claim 10, wherein the ceramic-like insulator is comprised of an alumina-boria-silica insulator.

12. The electrical circuit of claim 9, wherein the braiding is comprised of a high temperature braided sleeve.

13. The electrical circuit of claim 1, wherein each of the plurality of surfaces of the shaped portion is covered by a high temperature, porous, non-conducting insulation or braiding.

14. The electrical circuit of claim 1, wherein the anode conductor and the cathode conductor are disposed about an electrolyte material of a fuel cell.

15. The electrical circuit of claim 14, wherein the electrolyte material is comprised of a solid oxide electrolyte.

16. A method of increasing a surface area of at least one of an anode conductor and a cathode conductor, the method comprising:
providing at least one of an anode conductor and a cathode conductor, the anode conductor comprising a first wire and the cathode conductor comprising a second wire, each of the first wire and the second wire having a predetermined diameter; and
forming at least a portion of the predetermined diameter of at least one of the first wire and the second wire into a shaped portion having a plurality of surfaces, the plurality of surfaces providing an increased surface area of the shaped portion as compared to a remainder of the predetermined diameter.

17. The method according to claim 16, wherein the forming step comprises compressing at least one of the predetermined diameter of the first wire or the second wire to form a compressed shaped portion.

18. The method according to claim 17, wherein the predetermined diameter of the first wire or the second wire is about 0.0508 mm.

19. The method according to claim 18, wherein the compressed shaped portion has a thickness of about 0.127 mm and a width of about 1.143 mm.

20. The method according to claim 18, further comprising:
folding the width of the compressed shaped portion a plurality of times to form a plurality of folded surfaces, wherein each of the plurality of the folded surfaces has an equal height and an equal width.

21. The method according to claim 16, wherein the forming step comprises extruding at least a portion of the predetermined diameter of the first wire or the second wire to form a shaped portion having a plurality of surfaces, the shaped portion having a substantially similar cross-sectional area as the predetermined diameter.
